(19) United States
(12) Patent Application Publication
(10) Pub. No.: US 2025/0223952 A1
(43) Pub. Date: Jul. 10, 2025

(54) Speed Regulating Apparatus, Plunger Pump, and Fracturing Device

(71) Applicant: YANTAI JEREH PETROLEUM EQUIPMENT & TECHNOLOGIES CO., LTD., Yantai (CN)

(72) Inventors: Wenping CUI, Yantai (CN); Bo YU, Yantai (CN); Rikui ZHANG, Yantai (CN); Weichen LIU, Yantai (CN); Zimeng GUO, Yantai (CN)

(73) Assignee: YANTAI JEREH PETROLEUM EQUIPMENT & TECHNOLOGIES CO., LTD., Yantai (CN)

(21) Appl. No.: 19/089,655

(22) Filed: Mar. 25, 2025

Related U.S. Application Data
(63) Continuation of application No. PCT/CN2024/134588, filed on Nov. 26, 2024.

(30) Foreign Application Priority Data
Oct. 25, 2023 (CN) 202311394185.4

(51) Int. Cl. F04B 9/02; E21B 43/26; F16H 1/46; F16H 57/02; F16H 57/021

(52) U.S. Cl. CPC F04B 9/02; E21B 43/2607; F16H 1/46; F16H 57/021; F16H 2057/02073

(57) ABSTRACT

This application provides a speed regulating apparatus includes: a casing and a first speed regulating mechanism disposed in the casing. The first speed regulating mechanism includes a main power input component, an auxiliary power input component, and a speed regulating gear. The main power input component is a planetary gear set and includes a first input shaft, a first output shaft, and a plurality of first planetary gears. The first input shaft is configured to receive a driving force. The first output shaft is configured to output the driving force. The speed regulating gear is rotatably connected to the casing, and is in transmission connection with the plurality of first planetary gears separately. The auxiliary power input component includes an auxiliary power input gear rotatably connected to the casing, and the auxiliary power input gear is in transmission connection with the speed regulating gear.

### CROSS-REFERENCE TO RELATED APPLICATIONS

This application is a continuation of and claim the benefit of priority to PCT International Patent Application PCT/CN2024/134588, filed on Nov. 26, 2024, which claims priority to Chinese Patent Application No. 202311394185.4, entitled “SPEED REGULATING APPARATUS, PLUNGER PUMP, AND FRACTURING DEVICE”, filed with the China National Intellectual Property Administration on Oct. 25, 2023, which is incorporated herein by reference in its entirety.

### TECHNICAL FIELD

This application relates to the technical field of oil and gas equipment, and specifically, to a speed regulating apparatus, a plunger pump, and a fracturing device.

### BACKGROUND

As an important component of a fracturing device, a plunger pump is used to pump a working medium such as a sand-carrying fracturing fluid to a well after pressurization, so as to produce cracks in the formation in the well, increase the permeability of oil and gas resources, and implement a fracturing production operation. The performance of the plunger pump directly affects the oil and gas field fracturing construction operation. At present, the structures of fracturing plunger pumps mostly adopt horizontal and reciprocating multi-cylinder plunger pumps, for example, three-cylinder plunger pumps and five-cylinder plunger pumps, which are usually composed of three parts: a power end, a hydraulic end, and a reducer. The reducer functions to reduce the rotation speed of and increase the torque of an external power source. The power end functions to convert external power into a reciprocating movement through a crank connecting rod mechanism and transfer the reciprocating movement to the hydraulic end. The hydraulic end functions to convert mechanical energy transferred from the power end into pressure energy of the working medium.

The plunger pump is usually driven by a diesel engine and/or a motor. The diesel engine performs gear shifting through a gearbox. The motor implements stepless speed change through a frequency converter. Accompanied with the development of fracturing equipment technologies, fracturing devices using turbine engines as power sources emerge. Compared with diesel engines and motor drives, the turbine engines have many advantages, such as having a high power density of single machine, capable of using the natural gas as the fuel by 100% to reduce the fuel cost, and not requiring power supply.

turbine engines are grouped into single-shaft turbine engines and double-shaft turbine engines based on the basic structure. A double-shaft turbine engine allows an output rotation speed to operate at a variable speed within a range, and the output rotation speed of the single-shaft turbine engine is not regulable. Moreover, an existing plunger pump has a constant reduction ratio and cannot implement a speed regulating function. Therefore, all fracturing devices using turbine engines as power sources currently use double-shaft turbine engines. Thus, the choice for power sources are restricted.

### SUMMARY

An objective of the embodiments of this application is to provide a speed regulating apparatus, a plunger pump, and a fracturing device, which can solve the problems such as restrictions of power sources for a fracturing device.

To solve the technical problems, this application is implemented as follows:

An embodiment of this application provides a speed regulating apparatus, including: a casing and a first speed regulating mechanism disposed in the casing; the first speed regulating mechanism including a main power input component, an auxiliary power input component, and a speed regulating gear; the main power input component being a planetary gear set, the main power input component including a first input shaft, a first output shaft, and a plurality of first planetary gears, the first input shaft being configured to receive a driving force, and the first output shaft being configured to output the driving force; the speed regulating gear being rotatably connected to the casing, and being in transmission connection with the plurality of first planetary gears separately; and the auxiliary power input component including an auxiliary power input gear rotatably connected to the casing, and the auxiliary power input gear being in transmission connection with the speed regulating gear.

The embodiments of this application further provide a plunger pump, including: a power end assembly, a hydraulic end assembly, and the speed regulating apparatus; an output end of the speed regulating apparatus being in transmission connection with an input end of the power end assembly and an output end of the power end assembly being in transmission connection with an input end of the hydraulic end assembly; in a first working mode state, the main power input component being started and the auxiliary power input component being stopped, for the plunger pump to run at a first displacement; in a second working mode state, the main power input component being stopped and the auxiliary power input component being started, for the plunger pump to be started at a second displacement smaller than that of the first displacement and run at a variable speed; and
in a third working mode state, both the main power input component and the auxiliary power input component being started, for the plunger pump to be started at a third displacement greater than the first displacement and run at a variable speed.

The embodiments of this application further provide a fracturing device, including a power apparatus and the plunger pump; the power apparatus including a main power mechanism and an auxiliary power mechanism, the main power mechanism being in transmission connection with the main power input component, and the auxiliary power mechanism being in transmission connection with the auxiliary power input component; in a first working mode state, the main power input component being started and the auxiliary power input component being stopped, for the plunger pump to run at a first displacement; in a second working mode state, the main power input component being stopped and the auxiliary power input component being started, for the plunger pump to be started at a second displacement smaller than that of the first displacement and run at a variable speed; and in a third working mode state, both the main power input component and the auxiliary power input component being started, for the plunger pump to be started at a third displacement greater than the first displacement and run at a variable speed.

In the embodiments of this application, the output rotation speed of the speed regulating apparatus can be regulated by running at least one of the main power input component and the auxiliary power input component, to better adapt to a single-shaft turbine engine or other power sources having constant rotation speed outputs. Compared with the conventional reducers, the speed regulating apparatus in the embodiments of this application has the function of regulating the output rotation speed. By starting through the main power input component, a constant rotation speed or a constant output during an operation can be stabilized. By starting through the auxiliary power input component, the rotation speed during a small displacement operation can be regulated. By starting through the main power input component and the auxiliary power input component separately, the rotation speed during a large displacement operation can be regulated. Therefore, the speed regulating apparatus in the embodiments of this application has a strong applicability.

### BRIEF DESCRIPTION OF THE DRAWINGS

FIG. 1 is an example schematic structural diagram of a speed regulating apparatus according to an embodiment of this application;

FIG. 2 is an example cross-sectional view of FIG. 1 along a line A-A;

FIG. 3 is an example cross-sectional view of FIG. 1 along a line B-B;

FIG. 4 is an example cross-sectional view of FIG. 1 along a line C-C;

FIG. 5 is an example cross-sectional view of a speed regulating gear according to an embodiment of this application;

FIG. 6 is an example schematic structural diagram of a transmission connection member according to an embodiment of this application;

FIG. 7 is an example schematic structural diagram of a plunger pump according to an embodiment of this application;

FIG. 8 is an example schematic diagram of principles of a plunger pump according to an embodiment of this application;

FIG. 9 is an example cross-sectional view of a plunger pump according to an embodiment of this application; and

FIG. 10 is an example schematic structural diagram of a fracturing device according to an embodiment of this application.

### DESCRIPTIONS OF REFERENTIAL NUMERALS

01—speed regulating apparatus;
10—casing;
20—first speed regulating mechanism;
21—main power input component; 211—first sun gear; 212—first planetary carrier; 213—first planetary gear; 214—first pin shaft;
22—auxiliary power input component; 221—auxiliary power input gear;
23—speed regulating gear; 231—first inner gear ring; 232—outer gear ring;
30—second speed regulating mechanism;
31—second sun gear; 32—second planetary carrier; 33—second planetary gear; 34—second inner gear ring; 35—second pin shaft;
02—power end assembly;
03—hydraulic end assembly;
04—transmission connection member;
05—power apparatus;
051—main power mechanism; 052—auxiliary power mechanism; 053—deceleration mechanism; 054—driving mechanism.

### DETAILED DESCRIPTION

The technical solutions in embodiments of this application are described in the following with reference to the accompanying drawings in the embodiments of this application. The described embodiments are merely examples. All other embodiments obtained by a person of ordinary skill in the art based on the embodiments of this application without making creative efforts shall fall within the protection scope of this application.

The specification and claims of this application, and terms “first” and “second” are used to distinguish similar objects, but are unnecessarily used to describe a specific sequence or order. It is to be understood that data used in this way is exchangeable in a proper case, so that the embodiments of this application described herein can be implemented in an order different from the order shown or described herein, and in addition, the objects distinguished by “first” and “second” are generally one type, and the number of the objects is not limited, for example, there may be one first object, or a plurality of first objects. In addition, “and/or” used in this specification and the claims represents at least one of the connected objects, and the character “/” generally indicates that the associated objects are in an “or” relationship.

The embodiments of this application are described below through specific embodiments with reference to the accompanying drawings in combination with specific application scenarios.

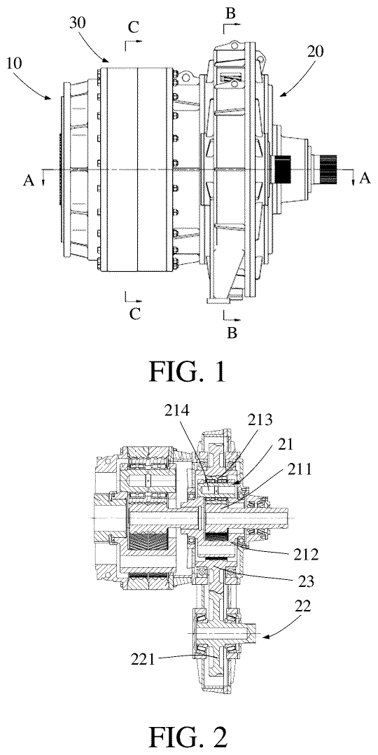

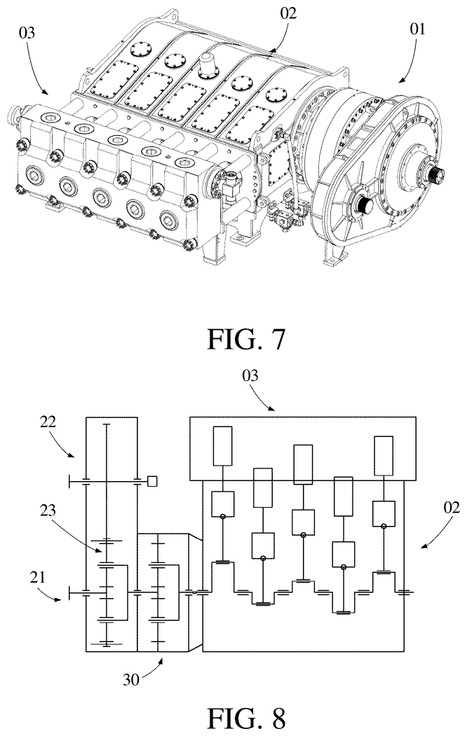

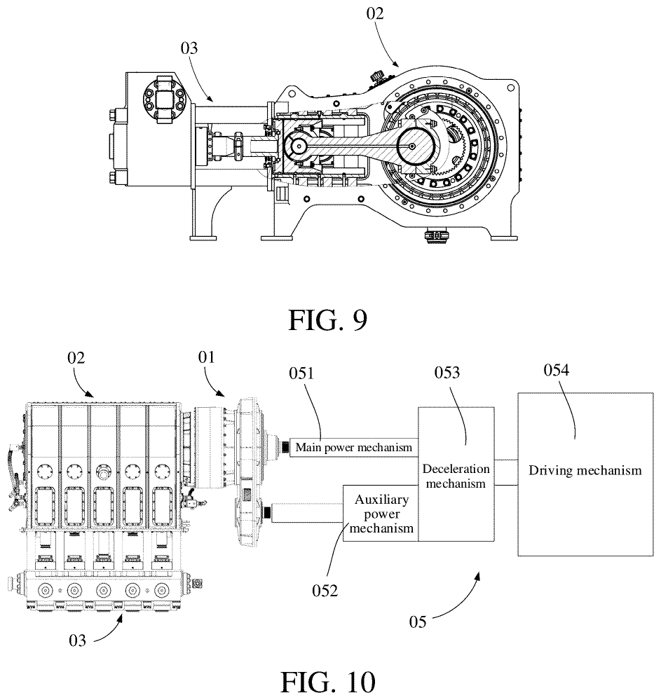

Referring to FIG. 1 to FIG. 10, the embodiments of this application provides a speed regulating apparatus. The provided speed regulating apparatus includes a casing 10 and a first speed regulating mechanism 20.

The casing 10 is a basic mounting member of the speed regulating apparatus and may provide a mounting base for the first speed regulating mechanism 20 or the like. The first speed regulating mechanism 20 functions to regulate the output rotation speed. In some embodiments, the first speed regulating mechanism 20 is disposed in the casing 10. Through the casing 10, the first speed regulating mechanism 20 can be installed, and the first speed regulating mechanism 20 can be protected.

Referring to FIG. 2, the first speed regulating mechanism 20 includes a main power input component 21, an auxiliary power input component 22, and a speed regulating gear 23. The main power input component 21 may be provided with a main power input interface, which is configured to be in transmission connection with a main power source (for example, the main power mechanism 051 below), so that the main power source can transmit power to the main power input component 21 via the main power input interface. Therefore, the first speed regulating mechanism 20 can output power and movement of a first form. The auxiliary power input component 22 may be provided with an auxiliary power input interface, which is configured to be in transmission connection with an auxiliary power source (for example, the auxiliary power mechanism 052 below), so that the auxiliary power source can transmit power to the auxiliary power input component 22 via the auxiliary power input interface. Therefore, the first speed regulating mechanism 20 can output power and movement of a second form. Certainly, during operation of the main power input component 21, the auxiliary power input component 22 may also be started, so as to regulate the power and movement outputted by the first speed regulating mechanism 20.

The auxiliary power input component 22 may be in transmission connection with the main power input component 21 through the speed regulating gear 23, so as to facilitate the regulation of the power and movement. The speed regulating gear 23 is rotatably connected to the casing 10.

In some embodiments, the main power input component 21 may be a planetary gear set. The main power input component 21 may include a first input shaft, a first output shaft, and a plurality of first planetary gears 213. The first input shaft is configured to receive a driving force. The first output shaft is configured to output a driving force. For example, the first input shaft may be in transmission connection with an upstream main power source, so that the main power source may transmit a driving force to the first speed regulating mechanism 20 via the first input shaft. The first output shaft may be in transmission connection with a downstream mechanism, to drive the downstream mechanism to move.

The speed regulating gear 23 is in transmission connection with the plurality of first planetary gears 213 separately. In this way, when the auxiliary power input component 22 drives the speed regulating gear 23 to move, the plurality of first planetary gears 213 can be separately driven to move through the speed regulating gear 23, to change a movement form of the planetary gear set, so as to function to regulate the speed.

Specifically, the auxiliary power input component 22 may include an auxiliary power input gear 221. The auxiliary power input gear 221 is rotatably connected to the casing 10 and the auxiliary power input gear 221 is in transmission connection with the speed regulating gear 23. Based on the above, the auxiliary power input gear 221 can drive the speed regulating gear 23 to move, so that the speed regulating gear 23 drives the plurality of first planetary gears 213 to move separately, so as to implement speed regulation.

Based on the above arrangements, in the embodiments of this application, the output rotation speed of the speed regulating apparatus can be regulated by running at least one of the main power input component 21 and the auxiliary power input component 22, to better adapt to a single-shaft turbine engine or other power sources having constant rotation speed outputs. Compared with the conventional reducers, the speed regulating apparatus in the embodiments of this application has the function of regulating the output rotation speed. By starting through the main power input component 21, a constant rotation speed or a constant output during an operation can be stabilized. By starting through the auxiliary power input component 22, the rotation speed during a small displacement operation can be regulated. By starting through the main power input component 21 and the auxiliary power input component 22 separately, the rotation speed during a large displacement operation can be regulated. Therefore, the speed regulating apparatus in the embodiments of this application has a strong applicability.

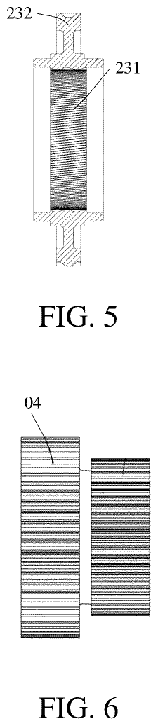

Referring to FIG. 5, to implement transmission of power and movement, the speed regulating gear 23 may be provided with a first inner gear ring 231 and an outer gear ring 232 coaxially arranged. The speed regulating gear 23 is nested on an outer side of the plurality of first planetary gears 213 and are meshed with the plurality of first planetary gears 213 through the first inner gear ring 231 separately. That is, the first planetary gear 213 is a gear, and the speed regulating gear 23 is further meshed with the auxiliary power input gear 221 through the outer gear ring 232. That is, the speed regulating gear 23 is a gear. Based on such the arrangement, the power and movement outputted by the auxiliary power input gear 221 may be transmitted to the plurality of first planetary gears 213 through the speed regulating gear 23, so that the movement form of the main power input component 21 under a driving action of the main power source can be changed, so as to function to regulate the speed.

For example, in a radial direction of the speed regulating gear 23, the first inner gear ring 231 and the outer gear ring 232 may be arranged opposite to each other. That is, an inner wall of the speed regulating gear 23 is provided with a ring of inner teeth to form the first inner gear ring 231 and an outer wall of the speed regulating gear 23 is provided with a ring of outer teeth to form the outer gear ring 232. By such the arrangement, the axial dimension of the speed regulating gear 23 can be reduced, the materials used can be reduced, the costs are reduced, and in addition, the uniformity of stress can be further improved.

In other embodiments, in an axial direction of the speed regulating gear 23, the first inner gear ring 231 and the outer gear ring 232 may be arranged in a staggered mode. That is, in the axial direction, the speed regulating gear 23 is divided into a first section and a second section. An inner wall of the first section is provided with a ring of inner teeth to form the first inner gear ring 231, and an outer wall of the second section is provided with a ring of outer teeth to form the outer gear ring 232. By such the arrangement, an inner stress region and an outer stress region of the speed regulating gear 23 can be separated, which can alleviate the problem that the stress in a same region is concentrated and is prone to damage. Therefore, the service life of the speed regulating gear 23 can be prolonged.

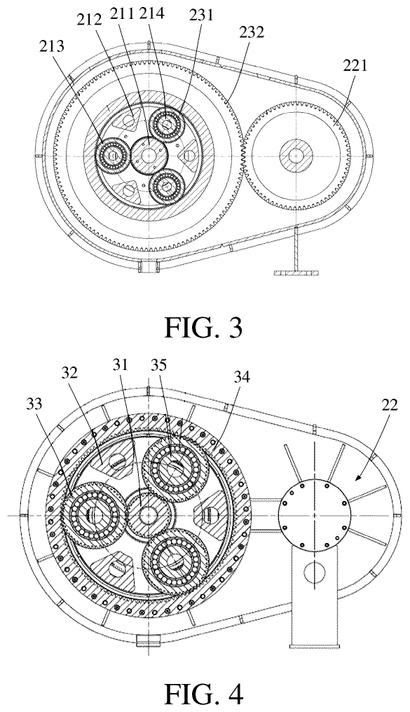

Referring to FIG. 2 and FIG. 3, in the embodiments of this application, the main power input component 21 may further include a first sun gear 211 and a first planetary carrier 212. The first sun gear 211 and the first planetary carrier 212 are rotatably connected to the casing 10 separately. The plurality of first planetary gears 213 are rotatably connected to the first planetary carrier separately and are in transmission connection with the first sun gear 211 separately. A rotating shaft of the first sun gear 211 is a first input shaft. A rotating shaft of the first planetary carrier 212 is a first output shaft.

Based on the above arrangement, when the main power source is started and the auxiliary power source is not started, a driving force of the main power source can be transmitted to the first sun gear 211 through the first input shaft, to drive the first sun gear 211 to rotate. Meanwhile, the first sun gear 211 further drives the plurality of first planetary gears 213 to spin and revolve. The plurality of first planetary gears 213 drive the first planetary carrier 212 to rotate. Finally, the power and movement (for example, a first constant speed) of the first form are transmitted to the downstream mechanism through the first output shaft.

When the auxiliary power input component 22 is started and the main power source is not started, the auxiliary power source drives the auxiliary power input gear 221 to rotate, the auxiliary power input gear 221 drives the speed regulating gear 23 to rotate, and the speed regulating gear 23 drives the plurality of first planetary gears 213 to spin and revolve. Meanwhile, the sun gear is fixed, the plurality of first planetary gears 213 drive the first planetary carrier 212 to rotate. Finally, the power and movement (for example, a second constant speed less than the first constant speed, or speed regulation) of the second form are transmitted to the downstream mechanism through the first output shaft.

When speed regulation is required, both the main power input component 21 and the auxiliary power input component 22 are started, so that the main power input component 21 can drive the first planetary carrier 212 to rotate through the first sun gear 211 via the plurality of first planetary gears 213, and meanwhile the auxiliary power input component 22 can drive the first planetary carrier 212 to rotate through the speed regulating gear 23 via the plurality of first planetary gears 213. Through combination of the two movement forms, the movement form of the first planetary carrier 212 can be changed, to perform the speed regulation. In addition, the speed can further be increased compared with the above two modes.

It should be noted here that the first speed regulating mechanism 20 can also function to reduce the speed and increase the torque.

In some embodiments, part of wheel members included in the first speed regulating mechanism 20 may be gears, and the gears may be helical gears, herringbone gears, spur gears, or the like, which may be specifically selected according to load conditions.

To achieve a further speed regulation effect, the speed regulating apparatus may further include a second speed regulating mechanism 30. The second speed regulating mechanism 30 is disposed in the casing 10 and is in transmission connection with the first output shaft. Specifically, the first speed regulating mechanism 20 is connected in series with the second speed regulating mechanism 30. Based on the above, the speed undergone regulation by the first speed regulating mechanism 20 can be secondarily regulated by the second speed regulating mechanism 30, so as to meet the movement requirement of a subsequently driven apparatus.

Referring to FIG. 4, in some embodiments, the second speed regulating mechanism 30 may alternatively be a planetary gear set, including a second sun gear 31, a second planetary carrier 32, a plurality of second planetary gears 33, and a second inner gear ring 34. The second sun gear 31 is rotatably connected to the casing 10. The plurality of second planetary gears 33 are rotatably connected to the second planetary carrier 32 separately and are in transmission connection with the second sun gear 31 separately. The second inner gear ring 34 is nested on an outer side of the plurality of second planetary gears 33 and is in transmission connection with the plurality of second planetary gears 33 separately. A rotating shaft of the second sun gear 31 is a second input shaft. A rotating shaft of the second planetary carrier 32 is a second output shaft.

Based on the above arrangement, when the second input shaft inputs a driving force, the second sun gear 31 rotates, the second sun gear 31 drives the plurality of second planetary gears 33 to spin and revolve separately, and the plurality of second planetary gears 33 drive the second inner gear ring 34 to rotate. Finally, the power and movement are transmitted to the downstream mechanism through the second output shaft.

It should be noted here that the second speed regulating mechanism 30 can function to reduce the speed and increase the torque.

Some wheel members included in the second speed regulating mechanism 30 may be gears, and the gears may be helical gears, herringbone gears, spur gears, or the like, which may be specifically selected according to load conditions.

In other embodiments, the second speed regulating mechanism 30 may alternatively be in other forms, such as a gear set, a worm gear set, a belt transmission set, or a chain transmission set, as long as the effects of reducing the speed and increasing the torque can be achieved, and the specific forms are not limited.

To implement the transmission connection between the first speed regulating mechanism 20 and the second speed regulating mechanism 30, the second sun gear 31 is in transmission connection with the first output shaft by a spline pair. By such the transmission mode, not only the transmission of power and movement can be implemented, but also relative positions between the second sun gear 31 and the first output shaft in the axial direction can be regulated, to avoid interference.

In other embodiments, the first output shaft and the rotating shaft (e.g., the second input shaft) of the second sun gear 31 may alternatively be connected through a coupling. In addition, other connection forms may alternatively be used, and are not specifically limited herein.

Referring to FIG. 3, to install the plurality of first planetary gears 213, the first planetary carrier 212 may be provided with a plurality of first pin shafts 214, the plurality of first pin shafts 214 are distributed centro-symmetrically relative to a central line of the first planetary carrier 212, and the plurality of first planetary gears 213 are rotatably connected to the plurality of first pin shafts 214 respectively. Based on the above, the first pin shaft 214 can support the corresponding first planetary gear 213 and ensure that the first planetary gear 213 can rotate. Therefore, under a driving action by at least one of the first sun gear 211 and the speed regulating gear 23, the plurality of first planetary gears 213 not only can spin around respective first pin shafts 214 thereof relative to the first planetary carrier 212, but also can drive the first planetary carrier 212 to rotate to implement revolution. In addition, through the rotation of the first planetary carrier 212, power and movement are transmitted through the rotating shaft of the first planetary carrier 212, to drive the downstream mechanism (e.g., the second speed regulating mechanism 30) to rotate.

Referring to FIG. 4, to install the plurality of second planetary gears 33, the second planetary carrier 32 may be provided with a plurality of second pin shafts 35, the plurality of second pin shafts 35 are distributed centro-symmetrically relative to a central line of the second planetary carrier 32, and the plurality of second planetary gears 33 are rotatably connected to the plurality of second pin shafts 35 respectively. Based on the above, the second pin shaft 35 can support the corresponding second planetary gear 33 and ensure that the second planetary gear 33 can rotate. Therefore, under a driving action by the second sun gear 31, the plurality of second planetary gears 33 not only can rotate relative to the second planetary carrier 32 around respective second pin shafts 35 thereof, but also can drive the second planetary carrier 32 to rotate to implement revolution. In addition, through the rotation of the second planetary carrier 32, power and movement are transmitted through the rotating shaft of the second planetary carrier 32, to drive the downstream mechanism to rotate.

Referring to FIG. 2, in some embodiments, an axis of the auxiliary power input component 22 is parallel to an axis of the speed regulating gear 23, and the main power input component 21 and the speed regulating gear 23 are coaxially arranged. Based on such the arrangement, the power and movement of the speed regulating gear 23 can be more directly transmitted to the main power input component 21, and an assembling space of the speed regulating gear 23 and the main power input component 21 can further be reduced to a particular extent, which is conducive to reducing an overall volume of the speed regulating apparatus and is further conducive to reducing entire complexity of the speed regulating apparatus.

In addition, a bottom portion of the first speed regulating mechanism 20 may further be provided with a base support structure, to fasten and support the first speed regulating mechanism 20.

In addition to the above structure, the speed regulating apparatus may further include structures such as bearings and flanges. Through the bearings, part of rotating components can be ensured to rotate smoothly, and through the flanges, part of structures can be installed. In addition, the casing 10 may include structures such as a case body and a case cover. Through the structures such as the case body and the case cover, internal rotating structural parts inside can be protected.

A power transmission path of the speed regulating apparatus in the embodiments of this application includes:

power from an upstream being inputted to the main power input component 21 to drive the first sun gear 211 to rotate, the first sun gear 211 driving the plurality of first planetary gears 213 to rotate, and the plurality of first planetary gears 213 driving the first planetary carrier 212 to rotate; the first planetary carrier 212 transmitting power and movement to the second sun gear 31, the second sun gear 31 driving the plurality of second planetary gears 33 to rotate, the plurality of second planetary gears 33 driving the second planetary carrier 32 to rotate, and the second planetary carrier 32 transmitting the power undergone speed reduction speed and torque increase to a downstream mechanism.

Speed regulating principles of the speed regulating apparatus in the embodiments of this application include:

Due to that the speed regulating gear 23 is driven by the auxiliary power input gear 221, based on a single-row planetary row equation:

$${n}_{sun} + α ⋆ {n}_{annulus} - ( 1 + α ) {n}_{carrier} = 0 .$$

nₛᵤₙ is the rotation speed of the first sun gear 211, nₐₙₙᵤₗᵤₛ is the rotation speed of the speed regulating gear 23, n_{carrier} the rotation speed of the first planetary carrier 212, and a is the ratio of the number of teeth zₐₙₙᵤₗᵤₛ of the speed regulating gear 23 to the number of teeth zₛᵤₙ of the first sun gear 211, that is, α=zₐₙₙᵤₗᵤₛ/zₛᵤₙ, and α>1. Therefore, the rotation speed calculation formula of the first planetary carrier 212 is:

$${n}_{carrier} = ( {n}_{sun} + α ⋆ {n}_{annulus} ) / ( 1 + α ) .$$

Based on the rotation speed calculation formula of the first planetary carrier 212, when the speed regulating gear 23 has no rotation speed, that is, when the rotation speed of the speed regulating gear 23 is 0, the rotation speed of the first planetary carrier 212 is:

$${n}_{carrier} = {n}_{sun} / ( 1 + α ) .$$

That is, the rotation speed transmitted by the first speed regulating mechanism 20 to the second sun gear 31 is:

$${n}_{sun 1} = {n}_{carrier} = {n}_{sun} / ( 1 + α ) .$$

Similarly, based on a planetary row equation:

$${n}_{sun 1} + {α}_{{1}^{*}} {n}_{annulus 1} - ( 1 + {α}_{1} ) {n}_{carrier 1} = 0.$$

nₛᵤₙ₁ is the rotation speed of the second sun gear 31, nₐₙₙᵤₗᵤₛ₁ is the rotation speed of the second inner gear ring 34, the rotation speed thereof being 0, n_{carrier1} is the rotation speed of the second planetary carrier 32, and α₁ is the ratio of the number of teeth zₐₙₙᵤₗᵤₛ₁ of the second inner gear ring 34 to the number of teeth zₛᵤₙ₁ of the second sun gear 31, that is, α₁=ₐₙₙᵤₗᵤₛ₁/zₛᵤₙ₁, and α₁>1. Therefore, the rotation speed calculation formula of the second planetary carrier 32 is:

$${n}_{carrier 1} = {n}_{sun 1} / ( 1 + {α}_{1} ) = {n}_{sun} / ( 1 + α ) / ( 1 + {α}_{1} ) .$$

That is, the rotation speed transmitted by the second speed regulating mechanism 30 to the downstream mechanism (for example, the power end assembly 02) is:

$${n}_{carrier 1} = {n}_{sun 1} / ( 1 + {α}_{1} ) = {n}_{sun} / ( 1 + α ) / ( 1 + {α}_{1} ) .$$

When auxiliary power is inputted to the auxiliary power input component 22 and the auxiliary power input gear 221 rotates, the auxiliary power input gear 221 may drive the speed regulating gear 23 to rotate. In this case, the rotation speed of the first planetary carrier 212 is n_{carrier}=(nₛᵤₙ+α*nₐₙₙᵤₗᵤₛ)/(1+α). In this way, when the rotation speed of the auxiliary power input gear 221 is the highest, that is, when the rotation speed of the corresponding speed regulating gear 23 is the highest, the rotation speed of the first planetary carrier 212 reaches the maximum, and the rotation speed transmitted to the downstream mechanism by the second speed regulating mechanism 30 is the maximum, that is, n_{carrier1}=nₛᵤₙ₁/(1+α₁)=(nₛᵤₙ+α*nₐₙₙᵤₗᵤₛ)/(1+α)/(1+α₁). In this way, by regulating the rotation speed nₐₙₙᵤₗᵤₛ of the speed regulating gear 23, the speed regulation of the downstream mechanism can be implemented.

Referring to FIG. 1 to FIG. 10, based on the speed regulating apparatus, the embodiments of this application further provides a plunger pump. The provided plunger pump includes a power end assembly 02, a hydraulic end assembly 03, and the speed regulating apparatus. An output end of the speed regulating apparatus is in transmission connection with an input end of the power end assembly 02. An output end of the power end assembly 02 is in transmission connection with an input end of the hydraulic end assembly 03.

In this way, in a first working mode state, the main power input component 21 is started, and the auxiliary power input component 22 is stopped, for the plunger pump to run at a first displacement.

In a second working mode state, the main power input component 21 is stopped and the auxiliary power input component 22 is started, for the plunger pump to be started at a second displacement smaller than that of the first displacement and run at a variable speed.

in a third working mode state, both the main power input component 21 and the auxiliary power input component 22 are started, for the plunger pump to be started at a third displacement greater than the first displacement and run at a variable speed.

Based on the above arrangement, in the first working mode state, that is, in a first single-power driving mode, power can be transmitted to the main power input component 21 through a main input interface, so that the plunger pump performs output at a constant moderate displacement (that is, the first displacement). The mode is suitable for stabilizing working conditions.

In the second working mode state, that is, in a second single-power driving mode, power can be transmitted to the auxiliary input assembly through the auxiliary input interface, so that the plunger pump is started and performs displacement regulation at a small displacement (that is, the second displacement). The mode is suitable for a small displacement working condition.

In the third working mode state, that is, in a dual-power driving mode, the main input interface and the auxiliary input interface respectively transmit power, so that the displacement of the plunger pump is increased and the plunger pump is started at a third displacement and can further run at a variable speed. The mode is suitable for large-batch operation conditions.

In the embodiments of this application, when the power and movement undergone the speed regulation are transmitted to the power end assembly 02 through the speed regulating apparatus, a crankshaft of the power end assembly 02 may drive a connecting rod, a crosshead, a pull rod, or the like to convert a rotary movement into a reciprocating linear movement, to drive a plunger of the hydraulic end assembly 03 to perform a reciprocating linear movement, so as to implement low-pressure intake and high-pressure output of a working medium and perform fracturing operation.

It should be noted herein that the specific structure of the plunger pump and the detailed working principles thereof may refer to the prior art, and are not specifically described herein.

In some embodiments, the plunger pump may further include a transmission connection member 04. The transmission connection member 04 is in transmission connection with an output end of the speed regulating apparatus and an input end of the power end assembly 02 by spline pairs, respectively. Based on such the arrangement, the power and movement outputted by the speed regulating apparatus can be transmitted to the power end assembly 02 through the transmission connection member 04, and the axial movement can be implemented, so as to properly adjust a relative position relationship between the speed regulating apparatus and the power end assembly 02, so as to effectively avoid interference problems.

Referring to FIG. 1 to FIG. 10, based on the above plunger pump, the embodiments of this application further provide a fracturing device. The fracturing device provided includes a power apparatus 05 and the plunger pump. The power apparatus 05 includes a main power mechanism 051 and an auxiliary power mechanism 052. The main power mechanism 051 is in transmission connection with the main power input component 21. The auxiliary power mechanism 052 is in transmission connection with the auxiliary power input component 22. In addition, the power apparatus 05 may further includes a driving mechanism 054 and a deceleration mechanism 053. The driving mechanism 054 is in transmission connection with the main power mechanism 051 and the auxiliary power mechanism 052 through the deceleration mechanism 053 separately.

In this way, in a first working mode state, the main power input component 21 is started, and the auxiliary power input component 22 is stopped, for the plunger pump to run at a first displacement.

In a second working mode state, the main power input component 21 is stopped and the auxiliary power input component 22 is started, for the plunger pump to be started at a second displacement smaller than that of the first displacement and run at a variable speed.

in a third working mode state, both the main power input component 21 and the auxiliary power input component 22 are started, for the plunger pump to be started at a third displacement greater than the first displacement and run at a variable speed.

Based on the above arrangement, an operation mode of the fracturing device can be changed correspondingly by changing a working mode of the plunger pump, so as to meet the requirements for the fracturing device under different working conditions.

To sum up, in the embodiments of this application, through the arrangement of the regulating apparatus, the plunger pump and even the fracturing device can be better adapted to a single-shaft turbine engine or other power sources having constant rotation speed outputs. Compared with a conventional plunger pump, the plunger pump in the embodiments of this application is equipped with a speed regulating apparatus having a speed regulating function, which can meet the displacement requirements under different working conditions by switching different power input interfaces, such as a constant rotation speed and a constant displacement during a stable operation, a rotation speed and displacement regulation during a small displacement operation, and a rotation speed and displacement regulation during a large displacement operation.

The embodiments of this application have been described above with reference to the accompanying drawings. This application is not limited to the specific embodiments described above, and the specific embodiments described above are merely exemplary and not limitative. Those of ordinary skill in the art may make various variations under the teaching of this application without departing from the spirit of this application and the protection scope of the claims, and such variations shall all fall within the protection scope of this application.

What is claimed is:

1. A speed regulating apparatus, comprising:
a casing (10);
a first speed regulating mechanism (20) disposed in the casing (10), the first speed regulating mechanism (20) comprising a main power input component (21), an auxiliary power input component (22), and a speed regulating gear (23), wherein:
the main power input component (21) comprises a first input shaft being configured to receive a driving force, a plurality of first planetary gears (213), and a first output shaft being configured to output the driving force;
the speed regulating gear (23) is rotatably connected to the casing (10) and is separately in transmission connection with the plurality of first planetary gears (213); and
the auxiliary power input component (22) comprises an auxiliary power input gear (221) rotatably connected to the casing (10), further in transmission connection with the speed regulating gear (23).

2. The speed regulating apparatus according to claim 1, wherein:
the speed regulating gear (23) further comprises a first inner gear ring (231) and an outer gear ring (232), the first inner gear ring (231) and the outer gearing ring (232) being coaxially arranged;
the speed regulating gear (23) is nested on an outer side of the plurality of first planetary gears (213) and is meshed with the plurality of first planetary gears (213) separately through the first inner gear ring (231); and
the speed regulating gear (23) is meshed with the auxiliary power input gear (221) through the outer gear ring (232).

3. The speed regulating apparatus according to claim 1, wherein:
the main power input component (21) further comprises a first sun gear (211) and a first planetary carrier (212), the first sun gear (211) and the first planetary carrier (212) being rotatably connected to the casing (10) separately; and
the plurality of first planetary gears (213) are rotatably connected to the first planetary carrier (212) and are further in transmission connection with the first sun gear (211), a rotating shaft of the first sun gear (211) being the first input shaft, and a rotating shaft of the first planetary carrier (212) being the first output shaft.

4. The speed regulating apparatus according to claim 3, wherein the speed regulating apparatus (01) further comprises a second speed regulating mechanism (30), the second speed regulating mechanism (30) being disposed in the casing (10) and being in transmission connection with the first output shaft.

5. The speed regulating apparatus according to claim 4, wherein the second speed regulating mechanism (30) comprises:
a second sun gear (31), the second sun gear (31) being rotatably connected to the casing (10), wherein a rotating shaft of the second sun gear (31) functions as a second input shaft;
a second planetary carrier (32), wherein a rotating shaft of the second planetary carrier (32) functions as a second output shaft;
a plurality of second planetary gears (33), the plurality of second planetary gears (33) being rotatably connected to the second planetary carrier (32) and being further in transmission connection with the second sun gear (31); and
a second inner gear ring (34), the second inner gear ring (34) being nested on an outer side of the plurality of second planetary gears (33) and being further in transmission connection with the plurality of second planetary gears (33).

6. The speed regulating apparatus according to claim 5, wherein the second sun gear (31) is in transmission connection with the first output shaft by a spline pair.

7. The speed regulating apparatus according to claim 5, wherein:
the first planetary carrier (212) comprises a plurality of first pin shafts (214), the plurality of first pin shafts (214) being distributed centro-symmetrically relative to a central line of the first planetary carrier (212); and
the plurality of first planetary gears (213) are rotatably connected to the plurality of first pin shafts (214).

8. The speed regulating apparatus according to claim 5, wherein: the second planetary carrier (32) comprises a plurality of second pin shafts (35), the plurality of second pin shafts (35) being distributed centro-symmetrically relative to a central line of the second planetary carrier (32); and
the plurality of second planetary gears (33) are rotatably connected to the plurality of second pin shafts (35).

9. The speed regulating apparatus according to claim 5, wherein:
an axis of the auxiliary power input component (22) is parallel to an axis of the speed regulating gear (23); and
the main power input component (21) and the speed regulating gear (23) are coaxially arranged.

10. A plunger pump comprising a power end assembly (02), a hydraulic end assembly (03), and a speed regulating apparatus (01) according to claim 1, wherein;
an output end of the speed regulating apparatus (01) is in transmission connection with an input end of the power end assembly (02), the output end of the power end assembly (02) being in transmission connection with an input end of the hydraulic end assembly (03);
in a first working mode state, the main power input component (21) is started and the auxiliary power input component (22) is stopped, for the plunger pump to run at a first displacement level;
in a second working mode state, the main power input component (21) is stopped and the auxiliary power input component (22) is started, for the plunger pump to be started at a second displacement level smaller than the first displacement level and to run at a variable speed; and
in a third working mode state, both the main power input component (21) and the auxiliary power input component (22) are started, for the plunger pump to be started at a third displacement level greater than the first displacement level and to run at a variable speed.

11. The plunger pump according to claim 10, wherein the plunger pump further comprises a transmission connection member (04), the transmission connection member (04) being in transmission connection with the output end of the speed regulating apparatus (01) and the input end of the power end assembly (02) by spline pairs.

12. A fracturing device comprising: a power apparatus (05) and the plunger pump according to claim 10, wherein:
the power apparatus (05) comprises a main power mechanism (051) and an auxiliary power mechanism (052), the main power mechanism (051) being in transmission connection with the main power input component (21), and the auxiliary power mechanism (052) being in transmission connection with the auxiliary power input component (22).
